(19) United States
(12) Patent Application Publication
(10) Pub. No.: US 2024/0046286 A1
(43) Pub. Date: Feb. 8, 2024

(54) TECHNOLOGY DELIVERY ENABLING HEATMAP WITH A SINGLE PANE VIEW

(71) Applicant: Bank of America Corporation, Charlotte, NC (US)

(72) Inventors: Shobha Jacob, Lisle, IL (US); Gilbert Gatchalian, Union, NJ (US); Bill Andrews, West Chicago, IL (US); Steven W. Cloutier, Plantsville, CT (US); Dale Daniel, Jacksonville, FL (US); Richard Drucker, Albany, NY (US); Eamon Glennon, Roscommon (IE); Haley Greiner, Moyock, NC (US); Eric Horrell, London (GB); Richard Larkin, Cranford, NJ (US); Trey McClendon, Waxhaw, NC (US); William McLain, Charlotte, NC (US); Stephen Robert Owen, Tokyo (JP); Philip Royes, Manalapan, NJ (US); Robert Schiavone, Monroe Township, NJ (US); Ada Zhao, Morganville, NJ (US); James Payton, Milton, GA (US); Edward Keenan, Garden City, NY (US)

(21) Appl. No.: 17/880,771

(22) Filed: Aug. 4, 2022

(51) Int. Cl. G06Q 30/02

(52) U.S. Cl. CPC G06Q 30/0202

(57) ABSTRACT

A method for enabling technology delivery using a heatmap with a single pane view is provided. The method may include validating and matching entity requirement data, demand forecast confidence and demand variances data. This ensures that each of the foregoing are combined to form a single format demand management heatmap portal. The method may include validating and matching time-to-market requirement data, at-risk projects data and hardware scarcity data. Once validated and matched, the time-to-market requirement data, the at-risk projects data and the hardware scarcity data may be combined to form a supply side capacity heatmap portal. The method may include validating and matching hardware product shortage data, data center/hosting capacity data and service requirements data. The hardware product shortage data, the data center/hosting capacity data and the service requirements data may then be combined to form a supply side capacity portal to determine availability and delivery risk.

### FIELD OF TECHNOLOGY

Aspects of the disclosure relate to providing solutions to technology delivery inefficiencies.

### BACKGROUND OF THE DISCLOSURE

Large entities often require delivery of technology infrastructure to meet regulatory and business objectives. Pursuant to the foregoing requirements, these large entities are often tasked with delivery of technology infrastructure.

Often, large entities exhibit an inability to identify supply to demand variances against forecasts relevant to the delivery of technology infrastructure solutions.

It would be desirable to provide a technical solution that highlights current and future capacity gaps. These capacity gaps relate to infrastructure.

Further, it would be desirable to provide a technical solution that impacts the end-to-end delivery lifecycle in a significant fashion.

### SUMMARY OF THE DISCLOSURE

It is an object of the invention to provide a technical solution that predicts, highlights and responds to current and future infrastructure capacity gaps. These capacity gaps relate at least in part directly to entity-based infrastructure.

It is a further object of the invention to provide a technical solution that impacts the end-to-end infrastructure delivery lifecycle in a significant fashion.

Demand management, project management, and service delivery reporting related to supply capacity may be used as inputs for a technological solution according to the disclosure. In embodiments of the invention, gathered data is coupled using “reference keys” to confirm data relationships across the various sources. Dissimilar data sources may be validated and matched.

In one embodiment of a single pane view according to the disclosure, three data groupings may be leveraged. These data groupings include infrastructure demand—i.e., what is entity-required; demand forecast confidence level and demand variances.

In addition, these data groupings for inputs to the system include technology dependencies—i.e., what drives the forecasted demand. Technology dependencies include time-to-market requirements, at-risk projects/programs and potential hardware scarcity.

Finally, these data groupings include supply side capacity—i.e., what determines availability and risk in delivery. Supply side capacity includes hardware product shortage, data center/hosting capacity and service requirements.

Using the foregoing three data groupings, the single pane view provides a glimpse into opportunities for improvement. Further, the single pane view enables, and pre-engineers, pro-actively overcoming and driving solutions across the remainder of the delivery.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows a schematic diagram in accordance with principles of the disclosure;

FIG. 4 shows a table of constituents in accordance with principles of the disclosure;

FIG. 5 shows a dataset development in accordance with principles of the disclosure;

FIG. 6 shows an infrastructure capacity heatmap in accordance with principles of the disclosure;

FIG. 7 shows a 30-day build forecast in accordance with principles of the disclosure; and

FIG. 8 shows a continuation of the 30-day build forecast of FIG. 7 in accordance with principles of the disclosure.

### DETAILED DESCRIPTION OF THE DISCLOSURE

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

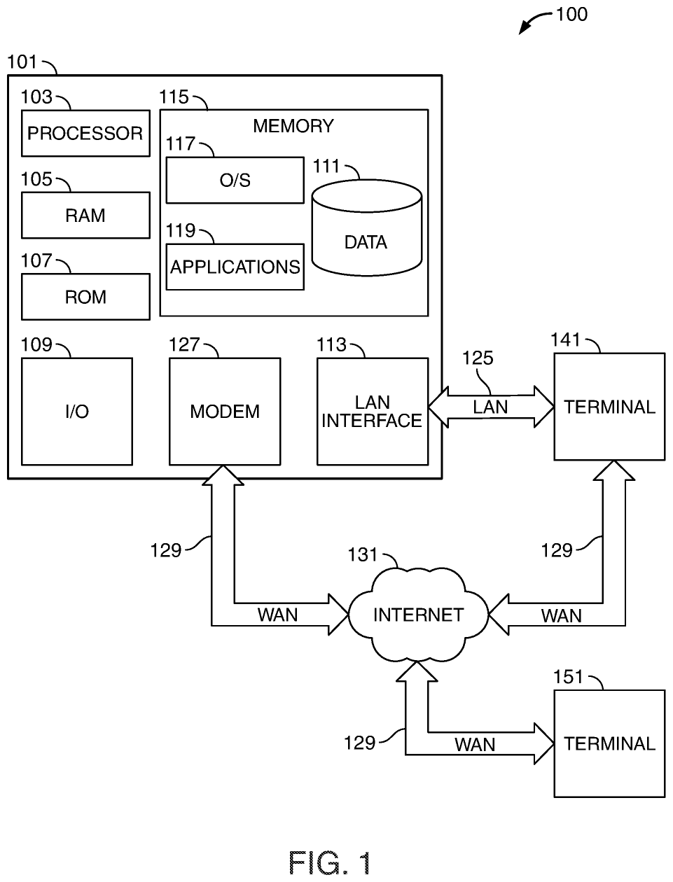

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of communications involving Artificial Intelligence (AI) as detailed herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

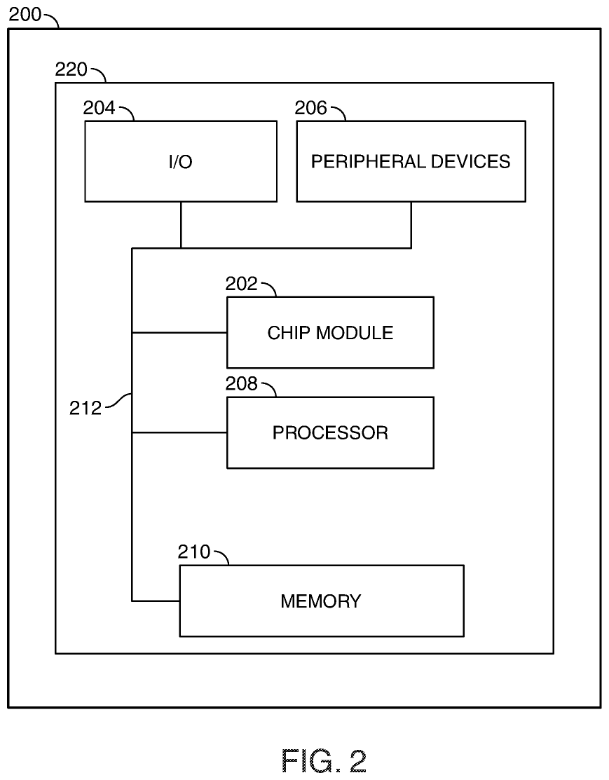

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

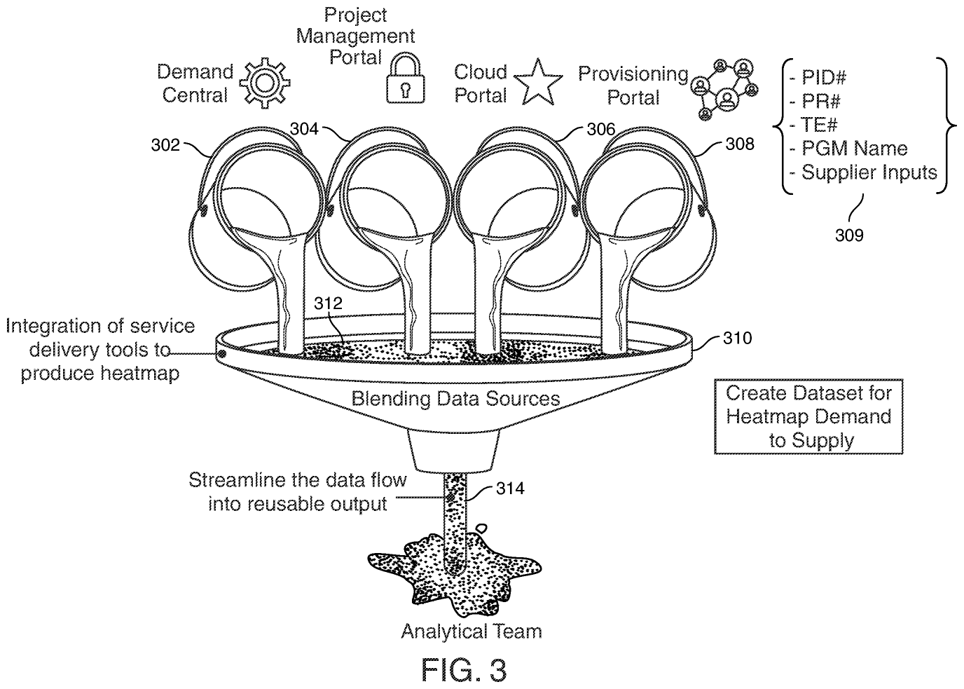

FIG. 3 shows a schematic diagram in accordance with principles of the disclosure.

FIG. 3 shows a demand central utility 302 that includes a hardware and software demand technology data library, a project management portal 304, a cloud management portal 306 including information derivable from the cloud regarding suppliers and other hardware and software providers, and a provisioning portal 308.

Some of the information provided from these various sources includes information shown in brackets 309. This information includes Project ID—PID #, Procurement Request Services—PR #, Governance Review TE #(which corresponds to the PID # and the PR #), Program—PGM—name and supplier inputs.

The integration of service delivery tools is shown schematically at 310. The data sources themselves, and the data drawn therefrom, are schematically depicted as being blended at 312.

In order to create a dataset for heatmap demand to supply, the dataflow is streamlined at 314 for provision to the analytical team.

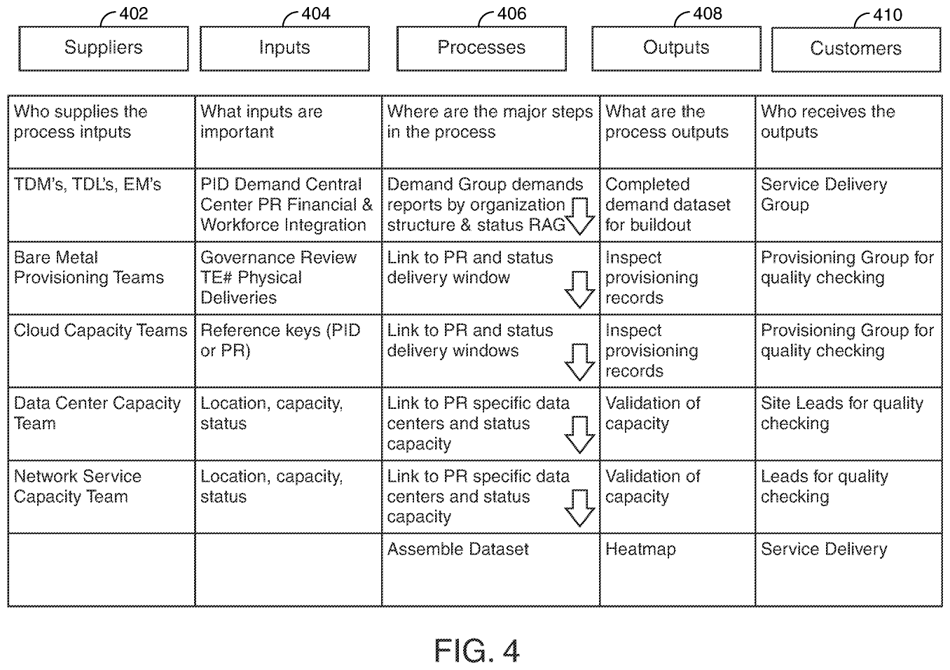

FIG. 4 shows a table of constituents in accordance with principles of the disclosure. Constituents of the systems and processes according to the disclosure include suppliers 402, inputs 404, processes 406, outputs 408, customers 410.

Suppliers 402 may include such information as who supplies the process inputs. Another of the constituents of the processes are the inputs themselves. The inputs 404 list what inputs are important or may play an important role in the process. Yet another of the constituents are the major steps of the process as shown at 406. The process outputs are listed at 408 and the recipients—i.e., customers—of the data are shown at 410.

Suppliers may include tech delivery managers (TDMs), tech delivery project leads (TDLs) and engagement managers (EMs.) Corresponding to these suppliers on the inputs are Project ID (PID), demand central center PR and Financial and Workforce Integration—all of which preferably include information relating to hardware/software demands of the entity. The major steps of the process 406 associated with the immediately foregoing suppliers 402 and inputs 404 are formulation of demand reports, and preparing group demands by organization structure and prioritizing using red light/amber light/green light (RAG) indicators. The process outputs 408 from the major steps may include a completed demand dataset for a software/hardware buildout. The recipients 410 of the outputs may include identification of the service delivery group.

Suppliers 402 may also include bare metal provisioning teams. These teams are in charge of knowledge of amount and location of inventory. Bare metal provisioning may correspond to inputs 404 such as TE (which corresponds to PR information) and physical deliveries. These may provide a link to PR and status delivery windows as the associated of process 406. These links may enable inspection of provisioning records as outputs at 408. Inspection of provisioning records may be performed by the provisioning group for quality checking, as shown at 410.

Suppliers 402 may also include cloud capacity teams. These teams may provide reference keys (PID or PR) as shown at 404. These may also provide a link to PR and status delivery windows as shown in the associated process 406. These links may enable inspection of provisioning records as outputs at 408. Inspection of provisioning records may be performed by the provisioning group for quality checking, as shown at 410.

Suppliers may include a data center capacity team 402. The inputs for this team may include location, capacity and status of deliverable software and hardware, as shown in 404. These may provide a link to PR specific data centers and status capacity as shown in 406 which will help to validate capacity as shown in 408 and provide site leads for quality checking at 410.

Suppliers may include a network service capacity team 402. The inputs for this team may include location, capacity and status of deliverable software and hardware, as shown in 404. These may provide a link to PR specific data centers and status capacity as shown in 406 which will help to validate capacity as shown in 408 and provide leads for quality checking at 410.

Based on suppliers 402, inputs 404, processes 406, outputs 408, customers 410, a dataset is assembled at 406, a heatmap is formulated at 408 and service delivery is confirmed at 410.

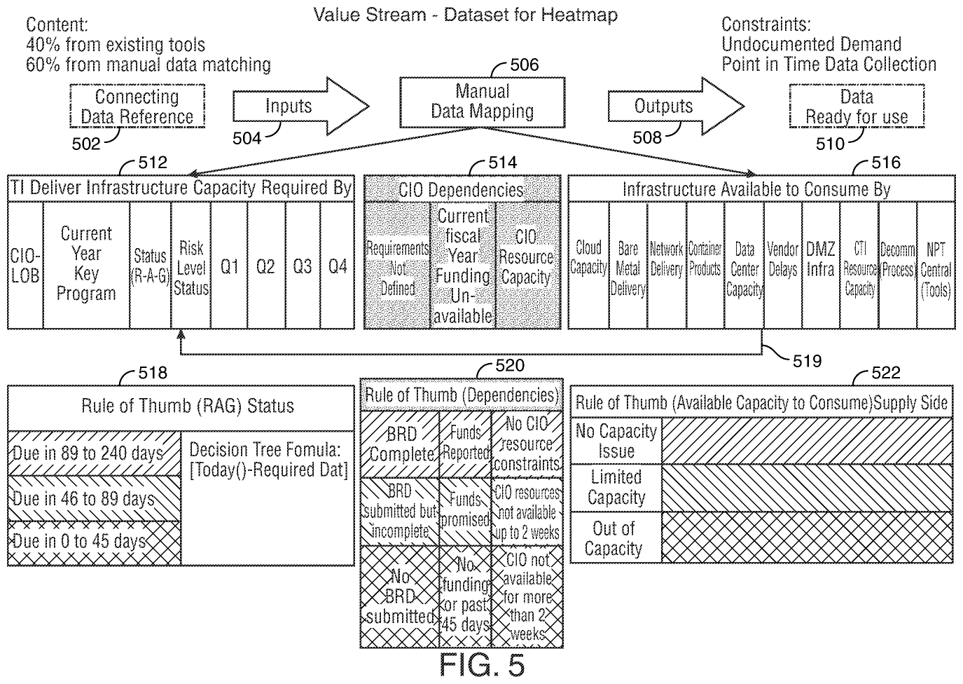

FIG. 5 shows dataset development in accordance with principles of the disclosure. The dataset may preferably be used to formulate the heatmap. This represents one understanding of a value stream contributed by the invention.

In some embodiments, the content for the data stream may be produced by a certain percentage—e.g., 40% —of existing automated tools and a certain percentage—e.g., 60%—of manual data matching. In other embodiments, the content can be wholly automated, wholly manual, or some combination of the two. The constraints for the data set may include an undocumented demand and a point in time data collection.

Steps that form the data set include connecting one or more reference(s) 502 with automated inputs 504 and manual data mapping 504. Outputs 508 may be produced to form data ready for use 510.

Manual data mapping may include technology deliver infrastructure capacity as required by the chief information office/line of business (CIO-LOB), current key program, status red, amber, green (R-A-G), risk level status, and individual quarters Q1, Q2, Q3 and Q4.

CIO dependencies 514 may also be included in the manual data mapping. These include requirements not (as yet) defined, current funding unavailable and CIO resource capacity.

The technology infrastructure may be available for consumption, as shown at 516, by the following sub-entities—cloud capacity, bare metal delivery, network delivery, container products, data center capacity, vendor delays, DMZ (demilitarized zone, such as a zone protected by one or more firewall(s)) infrastructure, core technology infrastructure capacity, decommissioning (process), and Not Permitted Technology (NPT) central tools.

It should be noted that, in certain embodiments, there may be a feedback loop from infrastructure available to consume by 516 and TI deliver infrastructure capacity required by 512. This feedback loop may characterize the relationship between the increase in available infrastructure and the concomitant decrease in required infrastructure.

Rule of thumb keys 518, 520 and 522 are shown at the bottom of FIG. 5. These include RAG status 518, dependencies 510 and available capacity to consume on the supply side 522.

RAG status 518 may typically be characterized by 89 to 240 days, 46 to 89 days and 0 to 45 days. The decision tree formula may include [today( )-Required Date].

Dependencies 520 may include three levels as well. Dependencies 520 may include business requirements document (BRD) complete, project fundings and no CIO resource constraints. Dependencies 520 may include BRD submitted but incomplete, funds promised and CIO resources not available for up to two weeks. Dependencies 520 may include no BRD submitted, no funding/or past 45 days and CIO resources not available for more than two weeks.

Available capacity to consume on the supply side may include one of the following: no capacity issue, limited capacity or out of capacity.

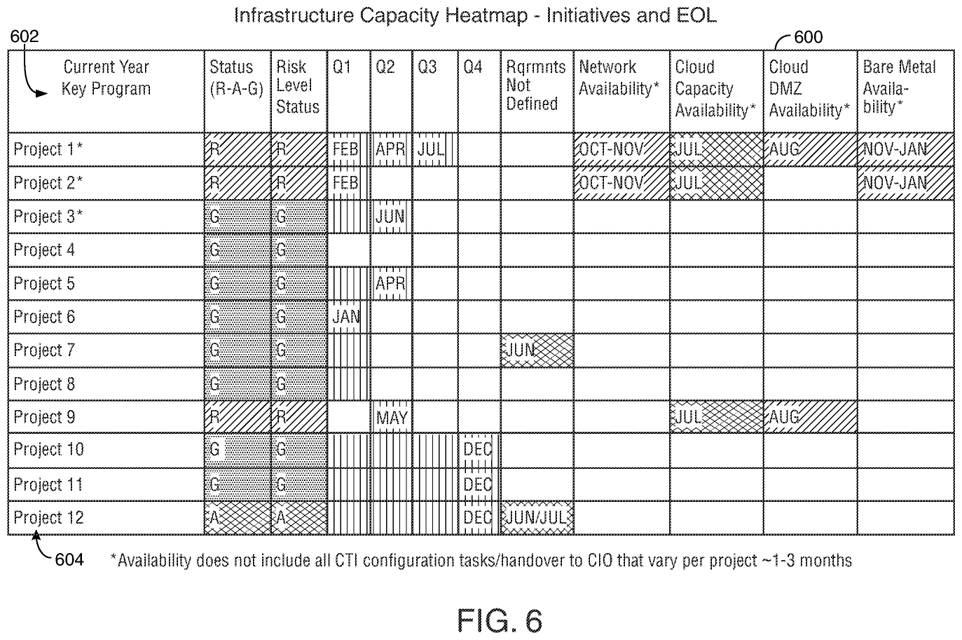

FIG. 6 shows an infrastructure capacity heatmap 600 in accordance with principles of the disclosure. The infrastructure capacity heatmap 600 includes across the top of the heatmap status (R-A-G), risk level status, Q1, Q2, Q3, Q4, requirements not defined, network availability, cloud capacity availability, DMZ availability, and bare metal availability. It should be noted that with respect to the asterisked columns, availability does not include all CTI configuration tasks/handover to CIO—these vary per product between 1-3 months.

The infrastructure capacity heatmap 600 includes down the left side 604 of the heatmap Project 1 and Project 2—i.e., this may represent, in certain embodiments, a mission critical function —, Project 3, Project 4, Project 5, Project 6, Project 7, Project 8, Project 9, Project 10, Project 11, and Project 12.

The following are exemplary major constraints that may be considered in formulating a heatmap such as the heatmap 600. It should be noted that the following constraints are only exemplary and are mentioned to provide context for the disclosure according to the embodiments set forth herein. Major constraints may include network equipment delivery delays due to supply chain shortages, bare metal capacity is available but cannot be provisioned due to the foregoing network equipment delays, cloud capacity may be limited/constrained across key data centers, cloud DMZ may be delayed due to limited IP address availability, and automated database cluster builds may be impacted due to build template issues.

Heatmap 600 has also indicated the importance of the following programs that, in exemplary heatmap 600, moving forward: Project 1, Project 2 and Project 3.

In an exemplary fashion, certain programs have been delayed/impacted by the foregoing constraints. These delayed/impacted programs include, for example, Project 1, Project 2 and Project 9.

Finally, mitigation steps, to offset the previously-mentioned constraints may include the following. The mitigation steps include the fact that prioritization will be given on a go-forward to priority-driven hardware requirements over initiative efforts, prioritization will be given to new infrastructure based on the programs that are delayed/impacted, temporary right-sizing capacity of servers based on constraints from inputs TI/CIO may be implemented, alternative data centers where capacity is available and latency is not an issue may be looked at for additional capacity and decommissioning may be expedited to reallocate capacity.

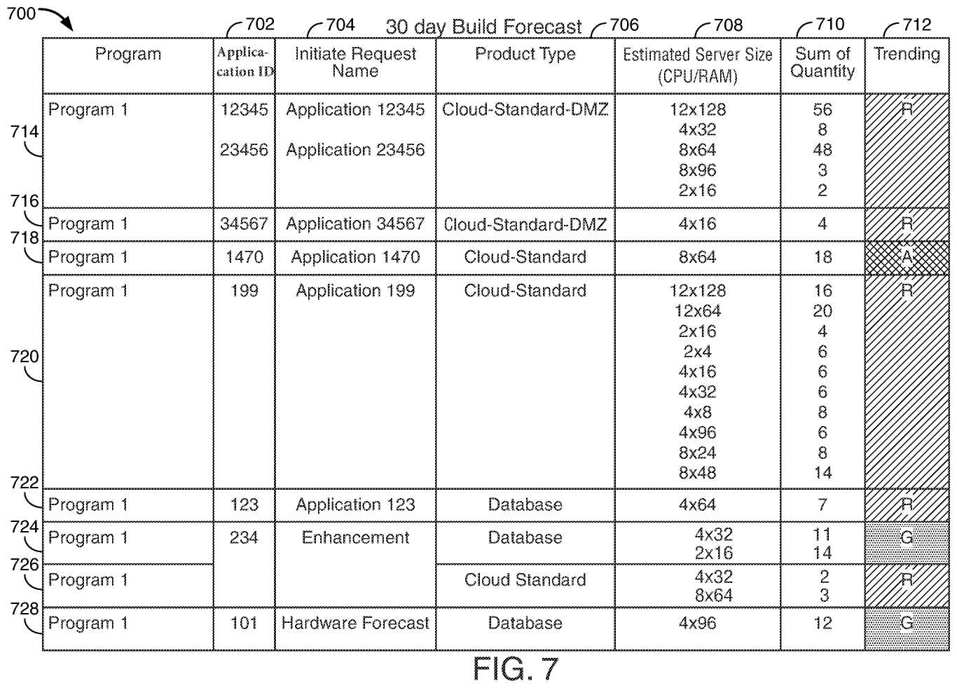

FIG. 7 shows a 30-day build forecast in accordance with principles of the disclosure. The 30-day view shown is a point in time view of build pipeline 700 for the next 30 days based on delivery plans. It should be noted that that across the top row of the forecast is shown the Application ID 702, the initiate request name 704, the product type 706, the estimated server size (CPU/RAM) 708, the sum of quantity 710 and the general trend of the infrastructure 712.

Down the left side of the build pipeline 700 is shown that entries 714, 716, 718, 720, 722, 724 and 726 related to build associated with Program 1. Entry 728 relates to Program 2.

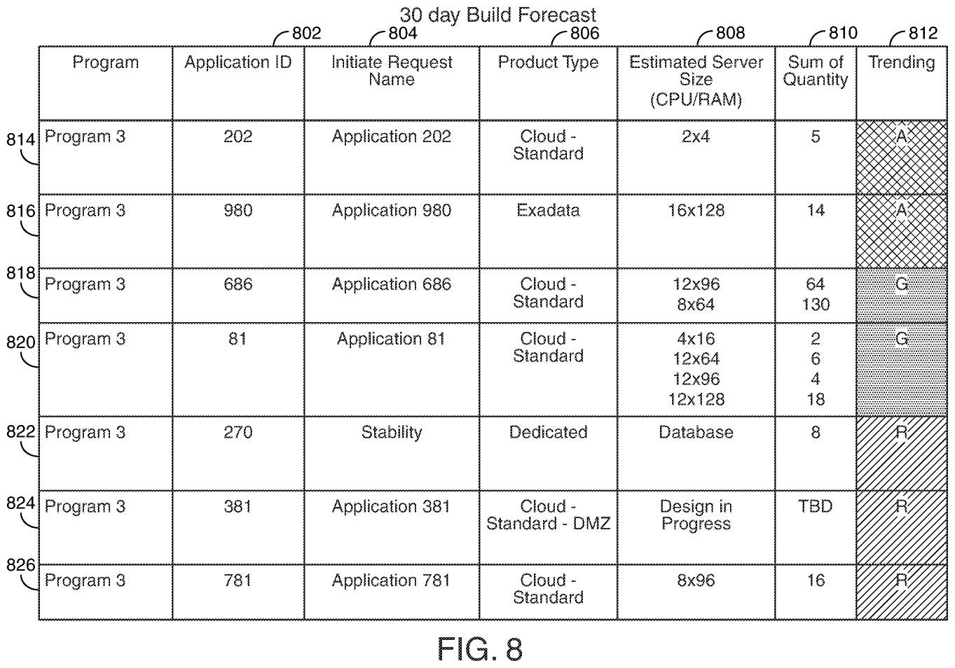

FIG. 8 shows a continuation of the 30-day build forecast 800 of FIG. 7 in accordance with principles of the disclosure. It should be noted that across the top row of the forecast 800 is shown the Application ID 802, the initiate request name 804, the product type 806, the estimated server size (CPU/RAM) 808, the sum of quantity 810 and the general trend of the infrastructure 812.

Down the left side of the build pipeline 800 is shown that entries 814, 816, 818, 820, and 822 relate to Program 3. Entry 724 relates to Program 5 and entry 726 relates to Program 6.

Thus, systems and methods for providing enhanced security features in a TECHNOLOGY DELIVERY ENABLING SINGLE PANE VIEW. Persons skilled in the art will appreciate that the present invention can be practiced by other than the described embodiments, which are presented for purposes of illustration rather than of limitation. The present invention is limited only by the claims that follow.

What is claimed is:

1. One or more non-transitory computer-readable media storing computer-executable instructions which, when executed by a processor on a computer system, perform a method for enabling technology delivery using a heatmap with a single pane view, the method comprising:
providing a demand management heatmap portal, said demand management portal comprising:
entity requirement data;
demand forecast confidence data; and
demand variances data;
providing a demand technology dependency/forecast confidence heatmap portal, said demand technology dependency/forecast confidence heatmap portal comprising:
time-to-market requirement data;
at-risk projects data; and
hardware scarcity data;
providing a supply side capacity heatmap portal for determining availability and delivery risk, said supply side capacity heatmap portal comprising:
hardware product shortage data;
data center/hosting capacity data; and
service requirements data;
leveraging a plurality of reference keys for confirming a plurality of data relationships across the demand management heatmap portal, the demand technology dependency/forecast confidence heatmap portal and the supply side capacity heatmap portal.

2. The method of claim 1, wherein the plurality of reference keys comprises a project identification ID (PID) number.

3. The method of claim 1, wherein the plurality of reference keys comprises a procurement request services (PR) number.

4. The method of claim 1 wherein the plurality of reference keys comprises a program name (PGM).

5. The method of claim 1 wherein the plurality of reference keys comprises at least one of a plurality of supplier inputs.

6. The method of claim 1 further comprising validating and performing format matching on the entity requirement data, the demand forecast confidence data and the demand variances data, such that each of the entity requirement data, the demand forecast confidence and the demand variances data are combined in a single format responsive heatmap.

7. The method of claim 1 further comprising validating and performing format matching on the time-to-market requirement data, the at-risk projects and the hardware scarcity data, such that each of the time-to-market requirement data, the at-risk projects data and the hardware scarcity data are combined in a single-format responsive heatmap.

8. The method of claim 1 further comprising validating and performing format matching on the hardware product shortage data, data center/hosting capacity data and service requirements data, such that each of the hardware product shortage data, data center/hosting capacity data and service requirements data are combined in a single-format responsive heatmap.

9. A method for enabling technology delivery using a heatmap with a single pane view, the method comprising:
validating and matching entity requirement data, demand forecast confidence and demand variances data such that each of the entity requirement data, the demand forecast confidence and the demand variances data are combined to form a single format demand management heatmap portal;
validating and matching time-to-market requirement data, at-risk projects data and hardware scarcity data, such that the time-to-market requirement data, the at-risk projects data and the hardware scarcity data are combined to form a supply side capacity heatmap portal; and
validating and matching hardware product shortage data, data center/hosting capacity data and service requirements data, such that the hardware product shortage data, the data center/hosting capacity data and the service requirements data are combined to form a supply side capacity portal to determine availability and delivery risk.

10. The method claim 9 further comprising leveraging a plurality of reference keys to confirm data relationships across the demand management heatmap portal, the demand technology dependency/forecast confidence portal and the supply side capacity portal.

11. The method of claim 10, wherein the plurality of reference keys comprises a project identification ID (PID) number.

12. The method of claim 10, wherein the plurality of reference keys comprises a procurement request services (PR) number.

13. The method of claim 10 wherein the plurality of reference keys comprises a program name (PGM).

14. The method of claim 10 wherein the plurality of reference keys comprises at least one of a plurality of supplier inputs.
